(19) United States
(12) Patent Application Publication
(10) Pub. No.: US 2001/0046195 A1
(43) Pub. Date: Nov. 29, 2001

(54) Tilt detector

(76) Inventor: Mitsuhiro Togashi, Yokohama (JP)

Correspondence Address: MORGAN, LEWIS & BOCKIUS, 1800 M STREET NW, WASHINGTON, DC, 20036-5869, US

(21) Appl. No.: 09/819,005

(22) Filed: Mar. 28, 2001

(30) Foreign Application Priority Data
Mar. 28, 2000 (JP) 2000-89876

(51) Int. Cl. G11B 7/00

(52) U.S. Cl. 369/53.19

(57) ABSTRACT

A tilt detector for detecting a tilt at a high degree of precision without necessitating a complex construction. The tilt detector comprises a light emitting unit for emitting a beam of light on a track formed on a recording surface of an optical disc, a light receiving unit for receiving the beam of light from the light emitting unit, reflected from the optical disc, and outputting a light amount signal corresponding to the amount of the received light, and a calculation unit for calculating a tilt of the beam of light emitted on the recording surface of the optical disc relative to the recording surface on the basis of the light amount signal from the light receiving unit and outputting the calculated result as a tilt signal. The light receiving unit includes a receiving surface partitioned into a plurality of areas for receiving the beam of light reflected from the optical disc and outputting light amount signals corresponding to the amounts of the received light, respectively. The calculation unit is adapted to calculate the tilt of the beam of light emitted on the recording surface of the optical disc relative to the recording surface on the basis of the light amount signals from the respective areas of the light receiving unit and output the calculated result as the tilt signal.

### BACKGROUND OF THE INVENTION

1. Field of the Invention

The present invention relates in general to an optical disc track, and more particularly to a tilt detector for detecting a tilt of an optical axis of a beam of light, which is emitted by an optical pickup on a recording surface of an optical disc, relative to the recording surface.

2. Description of the Prior Art

It is commonly required that an optical pickup should be improved in precision to meet requirements for a densification of an optical disc. In particular, it is currently required that an optical axis of a beam of light, which is emitted by the optical pickup on a recording surface of the optical disc, that is, an optical axis of an object lens installed in the optical pickup should be perfectly perpendicular to the recording surface.

On the other hand, with the densification of the optical disc, the number of apertures (NA) of the object lens installed in the optical pickup increases and the beam of light emitted from the optical pickup has a shorter wavelength. As a result, a coma-aberration increases significantly due to a tilt of the optical axis of the beam of light emitted from the optical pickup relative to the recording surface of the optical disc, which leads to a keen need for detection of the tilt.

There have conventionally been proposed a variety of devices for detecting a tilt of an optical axis of a beam of light, which is emitted by an optical pickup on a recording surface of an optical disc, that is, an optical axis of an object lens installed in the optical pickup, relative to the recording surface. One such device comprises a first detector for detecting a tilt of the optical disc, and a second detector for detecting a tilt of the optical axis of the object lens installed in the optical pickup. In other words, this conventional tilt detector is adapted to perform a calculation operation on the basis of the tilt of the optical disc detected by the first detector and the tilt of the optical axis of the object lens detected by the second detector to obtain a relative tilt therebetween.

However, the above-mentioned conventional tilt detector has the following disadvantages. Namely, this conventional tilt detector is complicated in construction because it detects the tilt of the optical disc and the tilt of the optical axis of the object Lens, respectively.

Further, errors may present in absolute tilt values of the optical disc and the optical axis of the object lens, detected by the different detectors, due to scattering of amplifier gains in the respective detectors, which in turn leads to the occurrence of an error in a relative tilt value between the absolute tilt values, calculated at the final stage.

Furthermore, this device does not detect a coma-aberration generated in a spot on the optical disc directly from a tilt, but merely estimates the coma-aberration from the tilt. This coma-aberration estimation may often be in error.

### SUMMARY OF THE INVENTION

Therefore, the present invention has been made in view of the above problems, and it is an object of the present invention to provide a tilt detector which is capable of detecting a tilt at a high degree of precision without necessitating a complex construction.

In accordance with the present invention, the above and other objects can be accomplished by the provision of a tilt detector comprising light emitting means for emitting a beam of light on a track formed on a recording surface of an optical disc, light receiving means for receiving the beam of light from the light emitting means, reflected from the optical disc, and outputting a light amount signal corresponding to the amount of the received light, and calculation means for calculating a tilt of the beam of light emitted on the recording surface of the optical disc relative to the recording surface on the basis of the light amount signal from the light receiving means and outputting the calculated result as a tilt signal, wherein the light receiving means includes a receiving surface partitioned into a plurality of areas for receiving the beam of light reflected from the optical disc and outputting light amount signals corresponding to the amounts of the received light, respectively; and the calculation means is adapted to calculate the tilt of the beam of light emitted on the recording surface of the optical disc relative to the recording surface on the basis of the light amount signals from the respective areas of the light receiving means and output the calculated result as the tilt signal.

Preferably, the receiving surface of the light receiving means may be divided into first and second areas in a radial direction of the optical disc, each of the first and second areas being divided into three areas in a tangential direction of the track of the optical disc.

As an alternative, the receiving surface of the light receiving means may be divided into first and second areas in a tangential direction of the track of the optical disc, each of the first and second areas being divided into three areas in a radial direction of the optical disc.

Preferably, the calculation means may include first addition means for adding light amount signals from both side areas among the three areas of the first area of the receiving surface of the light receiving means; first division means for dividing a light amount signal from a central area of the first area by an output signal from the first addition means; second addition means for adding light amount signals from both side areas among the three areas of the second area of the receiving surface of the light receiving means; second division means for dividing a light amount signal from a central area of the second area by an output signal from the second addition means; and subtraction means for subtracting an output signal from the second division means from an output signal from the first division means and outputting the subtracted result as the tilt signal.

More preferably, the calculation means may further include inversion means for inverting the polarity of the tilt signal when a spot of light is projected on a groove of the recording surface of the optical disc or a land between adjacent grooves to read information from the optical disc or write information on the disc.

Alternatively, the receiving surface of the light receiving means may be divided in four in a radial direction of the optical disc and then in four in a tangential direction of the track of the disc.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the construction of a tilt detector in accordance with a first embodiment of the present invention;

FIG. 2 is a detailed block diagram of a light receiving unit and calculation unit in accordance with the first embodiment of the present invention;

FIG. 3 is a view showing the shape of a beam of light reflected from an optical disc;

FIG. 4 is a plan view of a zero-order beam of light (straight-traveling beam of light) and first-order diffracted beam of light received on a receiving surface of the light receiving unit;

FIG. 5 is a view showing a tilted state of the optical disc in a radial direction thereof;

FIG. 6 is a view illustrating the expression of the tilted state of the optical disc based on the amounts of light received by respective areas of the light receiving unit;

FIG. 7 is a block diagram showing the construction of a tilt detector in accordance with a second embodiment of the present invention;

FIG. 8 is a detailed diagram of a light receiving unit in accordance with a third embodiment of the present invention;

FIG. 9 is a block diagram showing the construction of a tilt detector in accordance with a fourth embodiment of the present invention;

FIGS. 10a and 10b are views showing the projections of light spots on a groove and land of the optical disc, respectively;

FIGS. 11a to 11d are views showing variations in light intensity distribution on a receiving surface of the light receiving unit based or a tilt and shift, respectively;

FIGS. 12a and 12b are views showing the comparison between beams of light reflected from the groove and land of the optical disc when a tilt is present in the radial direction of the disc;

FIGS. 13a and 13b are views showing the comparison between beams of light reflected from the groove and land of the optical disc when a tilt is present in a tangential direction of the disc;

FIGS. 14a and 14b are graphs showing variations of a tilt signal (sensor signal) based on a tilt of a beam of light relative to the optical disc; and

FIGS. 15a and 15b are graphs showing a tilt signal (sensor signal) and the result of simple subtraction (A3-B3) after a shift-based offset (tracking error signal) is canceled, respectively.

### DETAILED DESCRIPTION OF THE PREFERRED EMBODIMENTS

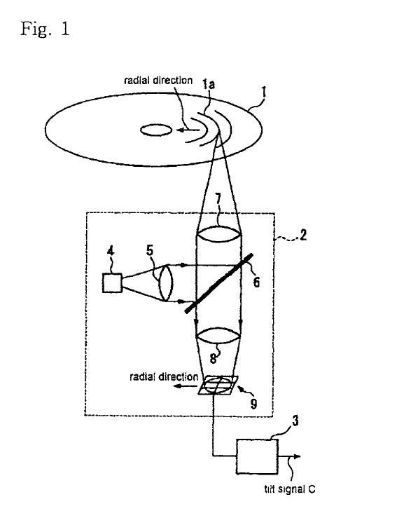

FIG. 1 is a view showing the construction of a tilt detector in accordance with a first embodiment of the present invention. In this embodiment, the tilt detector is adapted to detect a tilt in a radial direction of an optical disc.

In FIG. 1, the reference numeral 1 denotes an optical disc optically connected to the present tilt detector. The optical disc 1 has a track la for writing information thereon. This optical disc I is typically called a land/groove disc in that the track la consists of a groove and a land formed between adjacent grooves.

The reference numeral 2 denotes an optical pickup for reading the information written on the track la and detecting a tilt of an optical axis of a beam of light, which is emitted on a recording surface of the optical disc 1, relative to the recording surface. The reference numeral 3 denotes a calculation unit for performing a predetermined calculation operation for a light amount signal from the optical pickup 2 and outputting a tilt signal C indicative of a tilt amount as a result of the calculation operation.

The optical pickup 2 includes a plurality of internal components, namely, a light emitting unit 4, collimating lens 5, beam splitter 6, object lens 7, receiving lens 8 and light receiving unit 9.

The light emitting unit 4 is adapted to emit a beam of light to be incident on the optical disc 1. To this end, the light emitting unit 4 may include, for example, a laser diode. The collimating lens 5 acts to transform the beam of light emitted from the light emitting unit 4 into a collimated beam of light. The beam splitter 6 functions to refract an optical axis of the collimated beam of light from the collimating lens 5 by 90°. The object lens 7 is adapted to condense the collimated beam of light with the optical axis refracted by 90° by the beam splitter 6 to project a spot of light on the track 1a of the optical disc 1.

The beam of light projected on the track 1a of the optical disc 1 is reflected therefrom and then transmitted back to the beam splitter 6 via the object lens 7. Thereafter, the transmitted beam of light passes through the beam splitter 6 and arrives at the receiving lens 8. The receiving lens 8 directs the arriving beam of light onto a receiving surface of the light receiving unit 9, which will hereinafter be described in detail, so as to produce an image thereon. The light receiving unit 9 is adapted to receive She reflected beam of light at its receiving surface and output a light amount signal corresponding to the amount of the received light. To this end, the light receiving unit 9 may include, for example, a photodiode. The light amount signal outputted from the light receiving unit 9 is delivered to the calculation unit 3.

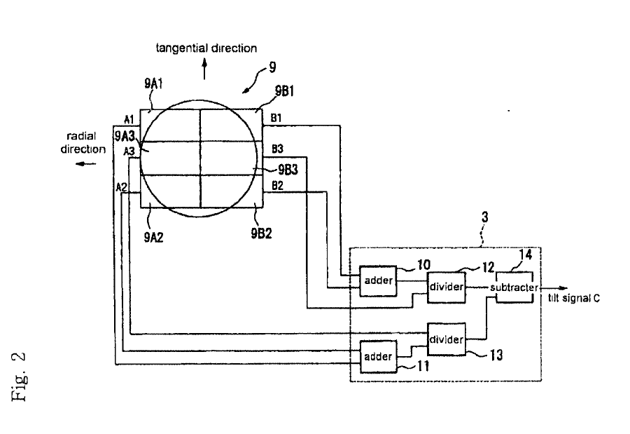

Next, the constructions of the light receiving unit 9 and calculation unit 3 will be described in detail with reference to FIG. 2. As shown in this drawing, the receiving surface of the light receiving unit 9 is partitioned into a total of six areas. Namely, the receiving surface of the light receiving unit 9 is divided in two in a radial direction of the optical disc 1 and then in three in a tangential direction of the track 1a of the disc 1.

The reference numerals 9A1, 9A2 and 9A3 denote three areas in one of the two parts divided in the radial direction of the optical disc 1, respectively. In more detail, the reference numerals 9A1 and 9A2 denote areas at both sides of one of the two parts divided in the radial direction of the optical disc 1, respectively, and the reference numeral 9A3 denotes the central area between the areas 9A1 and 9A2. Further, the reference numeral A1 denotes a light amount signal outputted from the area 9A1, A2 denotes a light amount signal outputted from the area 9A2, and A3 denotes a light amount signal outputted from the area 9A3.

The reference numerals 9B1, 9B2 and 9B3 denote three areas in the other of the two parts divided in the radial direction of the optical disc 1, respectively. In more detail, the reference numerals 9B1 and 9B2 denote areas at both sides of the other of the two parts divided in the radial direction of the optical disc 1, respectively, and the reference numeral 9B3 denotes the central area between the areas 9B1 and 9B2. Further, the reference numeral B1 denotes a light amount signal outputted from the area 9B1, B2 denotes a light amount signal outputted from the area 9B2, and B3 denotes a light amount signal outputted from the area 9B3.

The calculation unit 3 includes adders 10 and 11, dividers 12 and 13 and a subtracter 14. This calculation unit 3 may include a microcomputer, and the adders 10 and 11, dividers 12 and 13 and subtracter 14 may be implemented by, for example, arithmetic functions contained in the microcomputer.

The calculation unit 3 receives the light amount signals outputted from the respective areas of the light receiving unit 9 and performs a predetermined calculation operation for the received signals. That is, in the calculation unit 3, the adder 11 adds the light amount signals A1 and A2 and provides the added result A1+A2 to the divider 13, which also receives the light amount signal A3. Then, the divider 13 divides the light amount signal A3 by the added result A1+A2.

Also in the calculation unit 3, the adder 10 adds the light amount signals B1 and B2 and provides the added result B1+B2 to the divider 12, which also receives the light amount signal B3. Then, the divider 12 divides the light amount signal B3 by the added result B1+B2.

The dividers 13 and 12 provide the divided results to the subtracter 14, which then subtracts the divided result from the divider 12 from the divided result from the divider 13. As a result, the calculation unit 3 outputs the subtracted result as a tilt signal C indicative of a tilt in the radial direction of the optical disc 1. This calculation operation of the calculation unit 3 can be expressed by the following equation 1:

$$C = \frac{A3}{( A1 + A2 )} - \frac{B3}{( B1 + B2 )} \qquad \text{[Equation 1]}$$

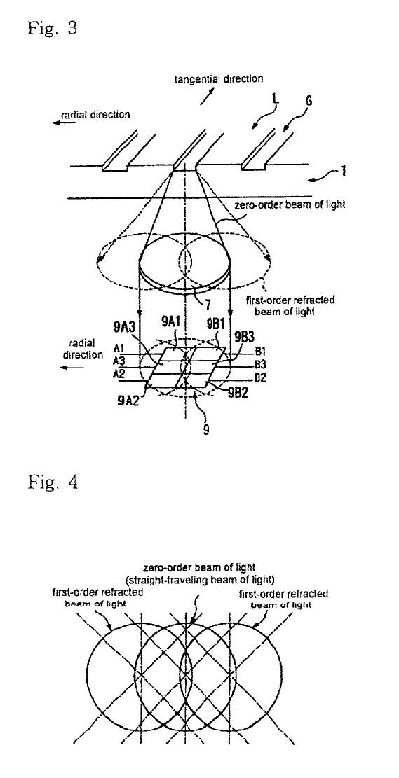

A detailed description will be given of the operation of the tilt detector with the above-stated construction in accordance with the first embodiment of the present invention. As shown in FIG. 3, a beam of light reflected from the optical disc 1 with the land L and groove G includes a directly reflected beam of light, or a zero-order beam of light, and a first-order refracted beam of light reflected by the land L and groove G. The zero-order beam of light and first-order refracted beam of light interfere with each other, resulting in their mixing.

FIG. 4 is a plan view of a zero-order beam of light (straight-traveling beam of light) and first-order diffracted beam of light received on the receiving surface of the light receiving unit 9. As shown in this drawing, the zero-order beam of light (straight-traveling beam of light) and first-order diffracted beam of light have an overlapping portion where they interfere with each other.

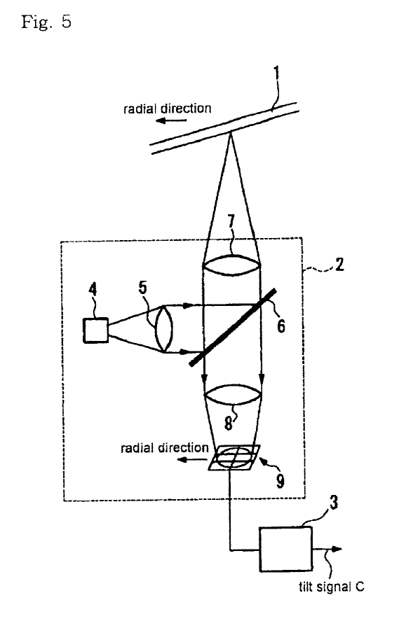

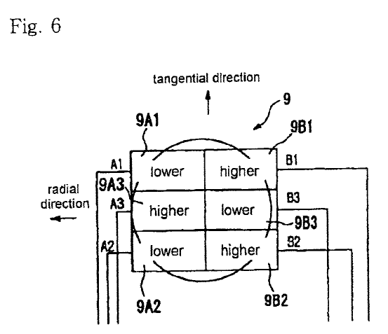

Assuming that the optical disc 1 has a tilt in its radial direction as shown in Fig 5, a deviation occurs in the amounts of light received by the respective areas 9A1 to 9A3 and 9B1 to 9B3 of the light receiving unit 9, as shown in FIG. 6. In other words, a coma-aberration is generated in a spot of light projected on the optical disc 1 due to the tilt of the disc 1, thereby causing a deviation to occur in the amounts of light received by the respective areas of the light receiving unit 9. This deviation occurs on the basis of an inverse relation between the areas 9A1 to 9A3 in the part A and the areas 9B1 to 9B3 in the part B. For example, as shown in FIG. 6, if a higher intensity of light is received by the central area 9A3 in the part A, higher intensities of light are received by the areas 9B1 and 9B2 at both sides of the part B.

A deviation in intensities of the received light occurs even when the optical disc I or light beam, namely, optical pickup 2 is shifted in the radial direction of the disc 1 and a spot of light is beyond the track 1a of the disc 1. For this reason, for example, in the case where only a difference between the light amount signal A3 from the area 9A3 and the light amount signal B3 from the area 9B3 is taken, an overlapped signal of a tracking error signal resulting from the shift and a tilt signal resulting from a tilt is obtained, thereby making it impossible to extract only the tilt signal. In order to solve this problem, according to the present invention, the calculation unit 3 performs the calculation operation as in the above equation I to extract only the tilt signal.

As an alternative, the calculation unit 3 may perform the below equation 2 to obtain the same effect:

$$C = \frac{A3}{( A1 + A2 + A3 )} - \frac{B3}{( B1 + B2 + B3 )} \qquad \text{[Equation 2]}$$

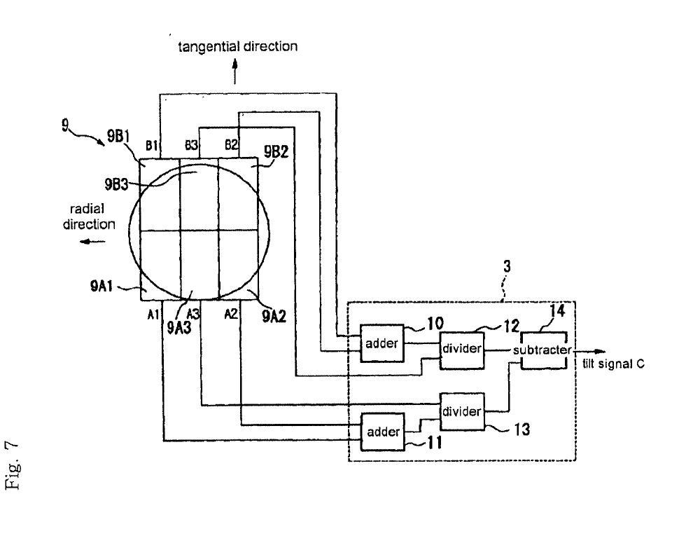

FIG. 7 is a block diagram showing the construction of a tilt detector in accordance with a second embodiment of the present invention. In this embodiment, the tilt detector is adapted to detect a tilt in the tangential direction of the track 1a of the optical disc 1. As shown in his drawing, the receiving surface of the light receiving unit 9 is partitioned into a total of six areas. Namely, the receiving surface of the light receiving unit 9 is divided in two in the tangential direction of the track 1a of the optical disc 1 and then in three in the radial direction of the disc 1.

In the second embodiment, the calculation unit 3 is the same in construction and operation (calculation operation) as that in the first embodiment. As a result of the calculation operation, the subtracter 14 in the calculation unit 3 outputs a tilt signal C indicative of a tilt in the tangential direction of the track la of the optical disc 1.

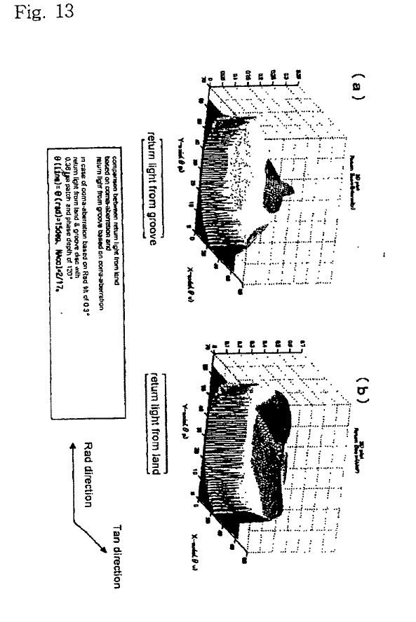

Coma-aberration effects appear as shown in FIGS. 13a and 13b in an interfering area of a zero-order beam of light and first-order refracted beam of light even though refracted beams of light are generated only in the radial direction of the optical disc. In this case, different light amount deviations are observed in the parts A and B of the light receiving unit 9 as shown in FIG. 7.

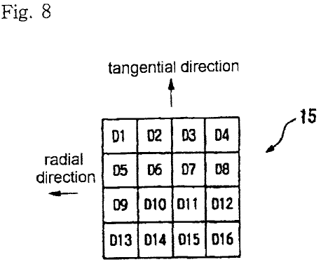

Next, a third embodiment of the present invention will be described with reference to FIG. 8. In this embodiment, the tilt detector is adapted to detect both the radial tilt and tangential tilt. As shown in this drawing, a receiving surface of a light receiving unit 15 is partitioned into a total of sixteen areas. Namely, the receiving surface of the light receiving unit 15 is divided in four in the radial direction and then in four in the tangential direction. This light receiving unit 15 is adapted to perform both the function of the light receiving unit for the detection of the radial tilt in the first embodiment and the function of the light receiving unit for the detection of the tangential tilt in the second embodiment. The components of the third embodiment other than the light receiving unit 15 are the same as those of the first or second embodiment and will thus not be shown.

For the detection of the radial tilt using the light receiving unit 15, the calculation unit performs a calculation operation as in the following equation 3:

$$C = \frac{( D5 + D6 + D9 + D10 )}{( D1 + D2 + D13 + D14 )} - \frac{( D7 + D8 + D11 + D12 )}{( D3 + D4 + D15 + D16 )} \qquad \text{[Equation 3]}$$

where, C is a radial tilt signal and D1 to D16 are light amount signals outputted from the respective areas of the light receiving unit 15 as shown in FIG. 8.

For the detection of the tangential tilt using the light receiving unit 15, the calculation unit performs a calculation operation as in the following equation 4:

$$C = \frac{( D14 + D10 + D15 + D11 )}{( D13 + D9 + D16 + D12 )} - \frac{( D6 + D2 + D7 + D3 )}{( D5 + D1 + D8 + D4 )} \qquad \text{[Equation 4]}$$

where, C is a tangential tilt signal and D1 to D16 are light amount signals outputted from the respective areas of the light receiving unit 15 as shown in FIG. 8.

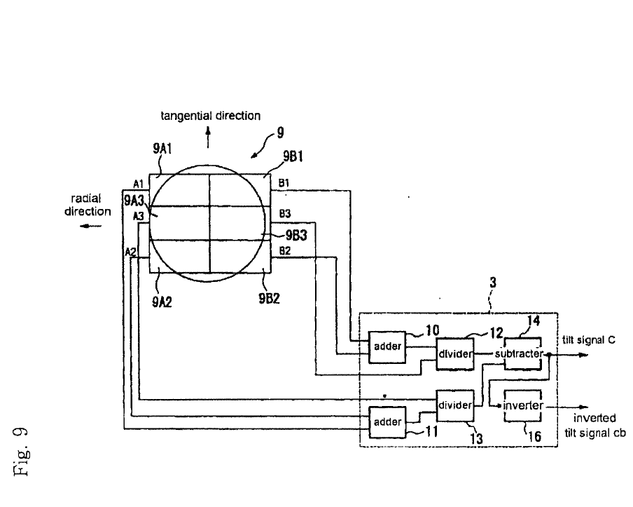

Next, a fourth embodiment of the present invention will be described with reference to FIG. 9. In this embodiment, the tilt detector is adapted to obtain the sum of the polarity of a tilt signal read from the land on the optical disc 1 and the polarity of a tilt signal read from the groove on the disc. To this end, the calculation unit 3 further includes an inverter 16 for inverting a tilt signal C from the subtracter 14 and outputting the inverted tilt signal Cb.

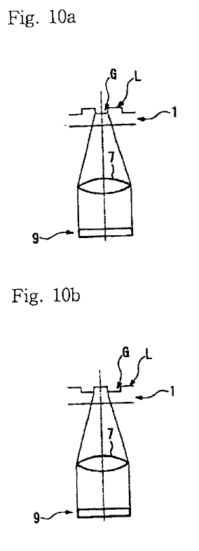

In the case where a spot of light is projected on the groove G of the optical disc 1 as shown in FIG. 10a and a spot of light is projected on the land L of the disc 1 as shown in FIG. 10b, refracted beams of light are inverted in polarity, thereby causing reflected beams of light to be inverted in strong and weak portions even when the optical disc 1 has a tilt in the same direction and the same coma-aberration is generated. For this reason, the tilt signal C is inverted in polarity when a spot of light is projected on the groove G and a spot of light is projected on the land L. In this regard, the inverter 16 is provided to make output signals En both cases the same in polarity. For example, for the projection of a spot of light on the groove G, the tilt signal C from the subtracter 19 is provided as the output signal of the tilt detector. For the projection of a spot of light on the land L, the inverted tilt signal Cb from the inverter 16 is provided as the output signal of the lilt detector.

In the fourth embodiment of FIG. 9, the inverter 16 is shown to be provided in addition to the construction of the first embodiment. Alternatively, the inverter 16 may be provided in addition to the construction of the second or third embodiment.

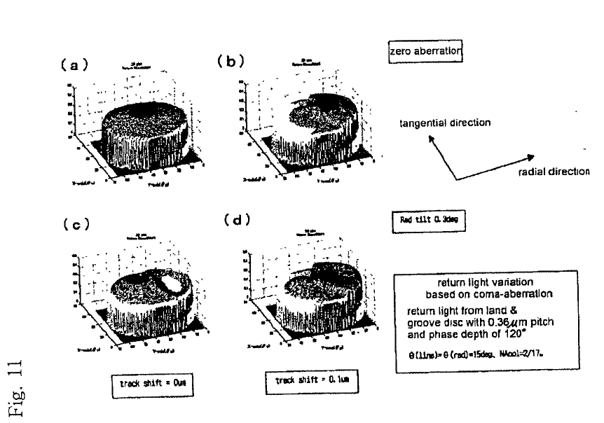

FIGS. 11 through 15 show the simulated results of the above-stated embodiments of the present invention. FIG. 11 shows variations in light intensity distribution on the receiving surface of the light receiving unit based on a tilt and shift, wherein FIG. 11a is a view showing a light intensity distribution based on neither tilt nor shift, FIG. 11b is a view showing a light intensity distribution based on only a shift, FIG. 11c is a view showing a light intensity distribution based on only a tilt and FIG. 11d is a view showing a light intensity distribution based on both a shift and tilt.

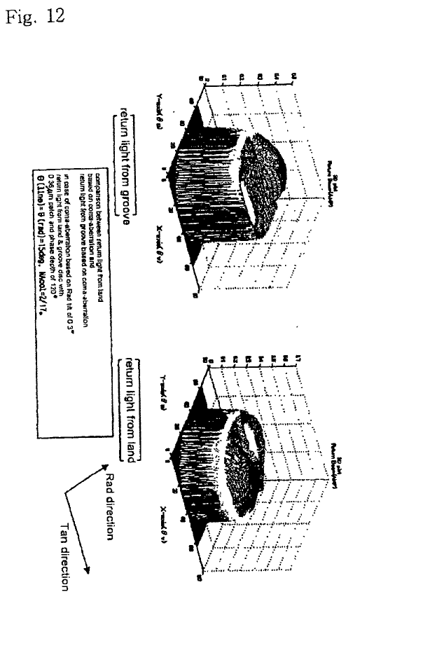

FIGS. 12 and 13 show the comparison between beams of light reflected from the groove and land of the optical disc. FIG. 12 shows the comparison between beams of light reflected from the groove and land of the optical disc when a tilt is present in the radial direction of the disc, wherein FIG. 12a is a view showing a beam of light reflected from the groove and FIG. 12b is a view showing a beam of light reflected from the land. As shown in these drawings, the beam of light reflected from the groove and the beam of light reflected from the land are inverted in intensity distribution. For this reason, according to the fourth embodiment of the present invention, the inverter 16 is provided in the calculation unit 3 to make generated signals the same in polarity. The inverter 16 inverts the tilt signal C in polarity and outputs the inverted tilt signal Cb. Finally, either the tilt signal C or inverted tilt signal Cb can be selected as the output signal of the tilt detector.

FIG. 13 shows the comparison between beams of light reflected from the groove and land of the optical disc when a tilt is present in the tangential direction of the disc, wherein FIG. 13a is a view showing a beam of light reflected from the groove and FIG. 13b is a view showing a beam of light reflected from the land. As shown in these drawings, the beam of light reflected from the groove and the beam of light reflected from the land are inverted in intensity distribution similarly to the above case where a tilt is present in the radial direction of the disc.

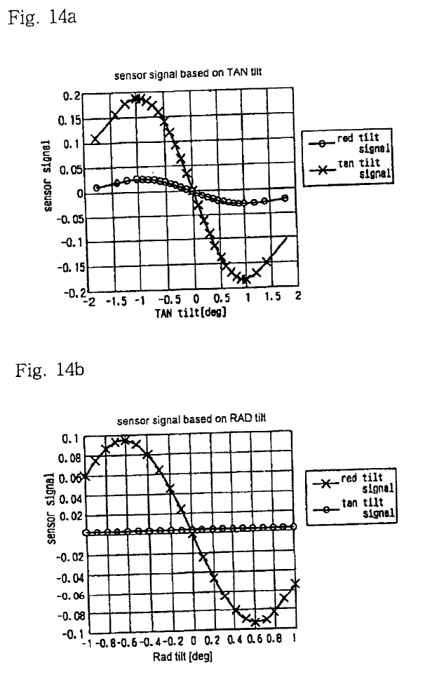

FIG. 14 shows variations of a tilt signal (sensor signal) based on a tilt of a beam of light relative to the optical disc, wherein FIG. 14a is a graph showing variations of a tilt signal (sensor signal) based on a tangential tilt. In this graph, a radial tilt signal and tangential tilt signal are shown. The tangential tilt results in a variation in the tangential tilt signal, but little variation in the radial tilt signal.

FIG. 14b is a graph showing variations of a tilt signal (sensor signal) based on a radial tilt. In this graph, a radial tilt signal and tangential tilt signal are shown, too. The radial tilt results in a variation in the radial tilt signal, but little variation in the tangential tilt signal, thereby exhibiting a preferred detection characteristic with no crosstalk.

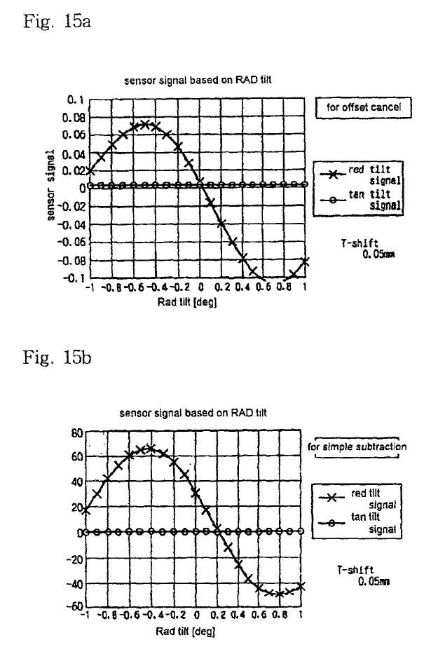

FIG. 15a is a graph showing a tilt signal (sensor signal) after a shift-based offset (tracking error signal) is canceled by the calculation unit 3. In this invention, the calculation unit 3 is adapted to perform a calculation operation to cancel a shift-based offset (tracking error signal). As a result, no offset (tracking error signal) is present in the output signal of the tilt detector.

FIG. 15b is a graph showing the result of simple subtraction (A3-B3). This result of simple subtraction represents that a shift-based offset (tracking error signal) overlaps a tilt signal. Hence, provided that a tilted angle in the radial direction is 0°, the radial tilt signal will not become 0.

As apparent from the above description, according to the present invention, the tilt detector need not detect the tilt of the optical disc and the tilt of the o tical axis of the object lens, respectively, and can detect a coma-aberration directly from a tilt, resulting in a simplification in construction.

Further, the operation of the present tilt detector is not subjected to effects from errors occurring while detecting an absolute value of the tilt of the optical disc and an absolute value of the tilt of the optical axis of the object lens. Furthermore, this tilt detector can detect a coma-aberration directly from a tilt. Therefore, the tilt detector need not estimate a coma-aberration from a tilt and can detect the tilt at a high degree of precision. Moreover, the tracking shift of the object lens causes no error in tilt signal, thereby enabling highly precise tilt detection.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A tilt detector comprising light emitting means for emitting a beam of light on a track formed on a recording surface of an optical disc, light receiving means for receiving the beam of light from said light emitting means, reflected from said optical disc, and outputting a light amount signal corresponding to the amount of the received light, and calculation means for calculating a tilt of said beam of light emitted on said recording surface of said optical disc relative to said recording surface on the basis of said light amount signal from said light receiving means and outputting the calculated result as a tilt signal, wherein said light receiving means includes a receiving surface partitioned into a plurality of areas for receiving said beam of light reflected from said optical disc and outputting light amount signals corresponding to the amounts of the received light, respectively; and
said calculation means is adapted to calculate said tilt of said beam of light emitted on said recording surface of said optical disc relative to said recording surface on the basis of the light amount signals from the respective areas of said light receiving means and output the calculated result as said tilt signal.

2. The tilt detector as set forth in claim 1, wherein said receiving surface of said light receiving means is divided into first and second areas in a radial direction of said optical disc, each of said first and second areas being divided into three areas in a tangential direction of said track of said optical disc.

3. The tilt detector as set forth in claim 1, wherein said receiving surface of said light receiving means is 10 divided into first and second areas in a tangential direction of said track of said optical disc, each of said first and second areas being divided into three areas in a radial direction of said optical disc.

4. The tilt detector as set forth in claim 2, wherein said calculation means includes:
first addition means for adding light amount signals from both side areas among the three areas of said first area of said receiving surface of said light receiving means;
first division means for dividing a light amount signal from a central area of said first area by an output signal from said first addition means;
second addition means for adding light amount signals from both side areas among the three areas of said second area of said receiving surface of said light receiving means;
second division means for dividing a light amount signal from a central area of said second area by an output signal from said second addition means; and
subtraction means for subtracting an output signal from said second division means from an output signal from said first division means and outputting the subtracted result as said tilt signal.

5. The tilt detector as set forth in claim 3, wherein sad calculation means includes:
first addition means for adding light amount signals from both side areas among the three areas of said first area of said receiving surface of said light receiving means;
first division means for dividing a light amount signal from a central area of said first area by an output signal from said first addition means;
second addition means for adding light amount signals from both side areas among the three areas of said second area of said receiving surface of said light receiving means;
second division means for dividing a light amount signal from a central area of said second area by an output signal from said second addition means; and
subtraction means for subtracting an output signal from said second division means from an output signal from said first division means and outputting the subtracted result as said tilt signal.

6. The tilt detector as set forth in claim 4, wherein said calculation means further includes inversion means for inverting the polarity of said tilt signal when a spot of light is projected on a groove of said recording surface of said optical disc or a land between adjacent grooves to read information from said optical disc or write information on said disc.

7. The tilt detector as set forth in claim 5, wherein said calculation means further includes inversion means for inverting the polarity of said tilt signal when a spot of light is projected on a groove of said recording surface of said optical disc or a land between adjacent grooves to read information from said optical disc or write information on said disc.

8. The tilt detector as set forth in claim 1, wherein said receiving surface of said light receiving means is divided in four in a radial direction of said optical disc and then in four in a tangential direction of said track of said disc.
